(19) United States
(12) Patent Application Publication
(10) Pub. No.: US 2026/0142319 A1
(43) Pub. Date: May 21, 2026

(54) BATTERY PACK AND VEHICLE INCLUDING THE SAME

(71) Applicant: LG ENERGY SOLUTION, LTD., Seoul (KR)

(72) Inventors: Hyuk-Kyun CHANG, Daejeon (KR); Soo-Youl KIM, Daejeon (KR); Gi-Chan PARK, Daejeon (KR); Beom-Seok CHOI, Daejeon (KR)

(21) Appl. No.: 19/316,642

(22) Filed: Sep. 2, 2025

(30) Foreign Application Priority Data
Nov. 19, 2024 (KR) 10-2024-0165158

(51) Int. Cl. H01M 50/383; B60L 50/64; H01M 10/625; H01M 10/647; H01M 10/658; H01M 50/211; H01M 50/249; H01M 50/30; H01M 50/342; H01M 50/358

(52) U.S. Cl. CPC H01M 50/383; H01M 10/625; H01M 10/647; H01M 10/658; H01M 50/211; H01M 50/249; H01M 50/3425; H01M 50/358; H01M 50/394; B60L 50/64; H01M 2220/20

(57) ABSTRACT

A battery pack including at least one battery assembly including a plurality of battery cells; a venting member including a venting portion in communication with the battery assembly and disposed on a first direction side of the battery assembly; a side wall frame surrounding the battery assembly from a lateral side and having a side venting channel formed therein, the side venting channel being in communication with the venting portion; and a louver member disposed between the venting portion and the side venting channel and configured to reduce flow energy of vent gas while suppressing or preventing backflow of the vent gas.

### CROSS-REFERENCE TO RELATED APPLICATIONS

This application is based on and claims priority to Korean Patent Application No. 10-2024-0165158 filed on Nov. 19, 2024, with the Korean Intellectual Property Office, the disclosure of which is incorporated herein in its entirety by reference.

### TECHNICAL FIELD

The present disclosure relates to a battery pack and a vehicle including the same.

### BACKGROUND

Secondary batteries, which have high applicability depending on the product group and electrical characteristics such as high energy density, are universally applied not only to the portable devices but also to the electric vehicles (EVs) or hybrid vehicles (HEVs) that are driven by electrical driving sources. Such secondary batteries are attracting attention as a new energy source for enhancing eco-friendliness and energy efficiency, not only because they have the primary advantage of drastically reducing the use of fossil fuels, but also because they generate no by-products from the use of energy.

Types of currently widely used secondary batteries include, for example, lithium ion batteries, lithium polymer batteries, nickel cadmium batteries, nickel hydrogen batteries, and nickel zinc batteries. When a high output voltage is required, a battery module or a battery pack may be configured by connecting a plurality of battery cells in series. In addition, in order to increase charge and discharge capacity, a battery module or a battery pack may also be configured by connecting a plurality of battery cells in parallel. Accordingly, the number of battery cells included in the battery module or pack may be variously set depending on the required output voltage or charge and discharge capacity.

When a battery pack is configured by connecting a plurality of battery cells in series and/or in parallel, it is common to first configure a battery module including at least one battery cell, and to configure a battery pack or a battery rack by using the at least one battery module and adding other components.

### SUMMARY

The present disclosure provides a battery pack capable of effective venting in the event of a thermal event, and a vehicle including the same.

The technical problems to be solved by the present disclosure are not limited to the above-mentioned problems, and other problems not mentioned above may be clearly understood by a person ordinarily skilled in the art from the description of the present disclosure set forth below.

A battery pack according to the present disclosure includes: at least one battery assembly including a plurality of battery cells; a venting member including a venting portion in communication with the battery assembly, the venting member being disposed on a first direction side of the battery assembly; a side wall frame surrounding the battery assembly from a lateral side and having a side venting channel formed therein, the side venting channel being in communication with the venting portion; and a louver member disposed between the venting portion and the side venting channel, the louver member being configured to reduce flow energy of vent gas while suppressing or preventing backflow of the vent gas.

The louver member may be provided in the form of an inclined plate with respect to a direction facing the venting portion and the side wall frame.

The battery pack according to the present disclosure may further include a venting device disposed on the side wall frame and configured to allow communication between the side venting channel and the outside of the battery pack.

The venting portion and the side venting channel may be formed perpendicular to each other.

The louver member may include: a first louver member extending in a direction away from the battery assembly from a position relatively closer to the battery assembly; and a second louver member extending in a direction toward the battery assembly from a position relatively farther from the battery assembly.

The first louver member may be formed to extend obliquely in a first direction, and the second louver member may be formed to extend obliquely in a second direction opposite to the first direction.

The first louver member may be obliquely formed at an obtuse angle in the first direction with respect to a direction from the side wall frame toward the battery assembly.

The battery pack according to the present disclosure may further include a venting device disposed on the side wall frame and configured to allow communication between the side venting channel and the outside of the battery pack, and the second louver member may not overlap the venting device when viewed from the battery assembly toward the side wall frame.

The sum of the extended length of the first louver member and the extended length of the second louver member may be equal to the internal width of the side venting channel.

The louver member may include a through-hole formed therethrough to allow the vent gas to pass.

The venting member may further include a side communication hole that allows communication between the venting portion and the side venting channel, and the louver member may be integrally formed with the venting member at the side communication hole.

The venting member may further include a cooling portion configured to cool the battery assembly.

The venting portion and the cooling portion may be alternately arranged.

The first direction may be a downward direction.

A fire-resistant sheet may further be included between the battery assembly and the venting member.

A vehicle according to the present disclosure includes at least one battery pack according to the present disclosure.

A battery pack case according to the present disclosure includes: an accommodation space configured to accommodate at least one battery assembly including a plurality of battery cells; a venting member including a venting portion in communication with the battery assembly, the venting member being disposed on a first direction side of the battery assembly; a side wall frame surrounding the battery assembly from a lateral side and having a side venting channel formed therein, the side venting channel being in communication with the venting portion; and a louver member disposed between the venting portion and the side venting channel, the louver member being configured to reduce flow energy of vent gas while suppressing or preventing backflow of the vent gas.

The louver member may be provided in the form of an inclined plate with respect to a direction facing the venting portion and the side wall frame.

The battery pack case according to the present disclosure may further include a venting device disposed on the side wall frame and configured to allow communication between the side venting channel and the outside of the battery pack.

The venting portion and the side venting channel may be formed perpendicular to each other.

According to the present disclosure, a battery pack capable of effective venting during a thermal event and a vehicle including the same may be provided.

According to an aspect of the present disclosure, a battery pack in which a flow path of vent gas is expanded and a vehicle including the same may be provided.

According to an aspect of the present disclosure, a battery pack capable of effectively reducing the flow energy of vent gas and a vehicle including the same may be provided.

According to an aspect of the present disclosure, a battery pack capable of effectively reducing the temperature and pressure of vent gas discharged to the outside of the battery pack, thereby suppressing external ignition, and a vehicle including the same may be provided.

According to an aspect of the present disclosure, a battery pack capable of removing ejected materials, such as ash or by-products and sparks in vent gas to be removed, at an early stage and a vehicle including the same may be provided.

According to an aspect of the present disclosure, a battery pack capable of effectively suppressing or preventing backflow of vent gas and a vehicle including the same may be provided.

According to an aspect of the present disclosure, a battery pack capable of effectively suppressing or preventing heat transfer phenomena and a vehicle including the same may be provided.

According to an aspect of the present disclosure, a battery pack with improved productivity and a vehicle including the same may be provided.

According to an aspect of the present disclosure, a battery pack capable of effectively cooling the battery assemblies and vent gas and a vehicle including the same may be provided.

According to an aspect of the present disclosure, a battery pack capable of ensuring the safety of passengers and a vehicle including the same may be provided.

The effects of the present disclosure are not limited to the aforementioned effects, and other effects not mentioned may be clearly understood by those ordinarily skilled in the art from the present specification and the accompanying drawings.

### BRIEF DESCRIPTION OF THE DRAWINGS

The following drawings attached hereto illustrate embodiments of the present disclosure and serve to further understand the technical idea of the present disclosure together with the content of the disclosure described above. Therefore, the present disclosure should not be construed as being limited to the matters illustrated in the drawings.

FIG. 1 is a perspective view illustrating an overall configuration of a battery pack according to an embodiment of the present disclosure.

FIG. 2 is a perspective view illustrating the battery pack of FIG. 1 viewed from another direction.

FIG. 3 is an exploded perspective view illustrating a pack cover separated from the battery pack according to an embodiment of the present disclosure.

FIG. 4 is an exploded perspective view illustrating a bottom plate and a venting member separated from the battery pack according to an embodiment of the present disclosure.

FIG. 5 is a cross-sectional perspective view illustrating a portion of a cross-section taken along line A-A′ of FIG. 1.

FIG. 6 is a cross-sectional perspective view illustrating a portion of a cross-section taken along line B-B′ of FIG. 1.

FIGS. 7 and 8 are enlarged side cross-sectional views illustrating a portion of a battery pack where a louver member is disposed, according to an embodiment of the present disclosure.

FIGS. 9A and 9B are enlarged side cross-sectional views illustrating a portion of a battery pack in which a louver member is disposed, according to a modification of an embodiment of the present disclosure.

FIG. 10 is an enlarged side cross-sectional view illustrating a portion in which a louver member is disposed in a battery pack according to another embodiment of the present disclosure.

FIG. 11 is a perspective view illustrating an overall configuration of a battery assembly according to an embodiment of the present disclosure.

FIG. 12 is a perspective view illustrating the battery assembly of FIG. 11 viewed from another direction.

FIG. 13 is a perspective view illustrating an overall configuration of a battery cell according to an embodiment of the present disclosure.

FIGS. 14 to 16 are bottom views illustrating a venting member according to an embodiment of the present disclosure.

FIG. 17 is an enlarged side cross-sectional view illustrating a portion of a battery pack according to another embodiment of the present disclosure.

FIG. 18 is a view illustrating a vehicle according to an embodiment of the present disclosure.

Corresponding reference characters indicate corresponding components throughout the several views of the drawings. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

Hereinafter, embodiments of the present disclosure will be described in detail with reference to the accompanying drawings. Prior to this, the terms or words used in the specification and claims should not be construed as limited to their ordinary or dictionary meanings, but should be construed in accordance with meanings and concepts consistent with the technical idea of the present disclosure based on the principle that an inventor may appropriately define the concepts of terms in order to explain their invention in the best way.

Accordingly, since the embodiments described in this description and the configurations illustrated in the drawings are merely some exemplary embodiments of the present disclosure, and do not represent all of the technical ideas of the present disclosure, it should be understood that at the time of filing, there may be various equivalents and modifications that could serve as alternatives to the embodiments.

In this specification, unless otherwise specified, the X-axis direction is referred to as the front-rear direction, the Y-axis direction perpendicular to the X-axis direction is referred to as the left-right direction, and the Z-axis direction perpendicular to the X-Y plane is referred to as the up-down direction (vertical direction).

When a large number of battery cells are included in a battery pack, the battery pack may be vulnerable to thermal chain reactions between battery cells or between battery modules. For example, when a thermal event such as thermal runaway occurs in any one of the battery cells, such a thermal event may propagate to other battery cells or battery modules. When such thermal transfer is not properly suppressed, the thermal event that occurred in a specific battery cell may cause a chain reaction in other battery cells or battery modules, leading to serious problems such as explosions or fires.

In view of these issues, the present disclosure provides a battery pack with improved venting efficiency, and a vehicle including the same, by, for example, expanding a flow path of vent gas to effectively reduce the flow energy of the vent gas when a thermal event occurs.

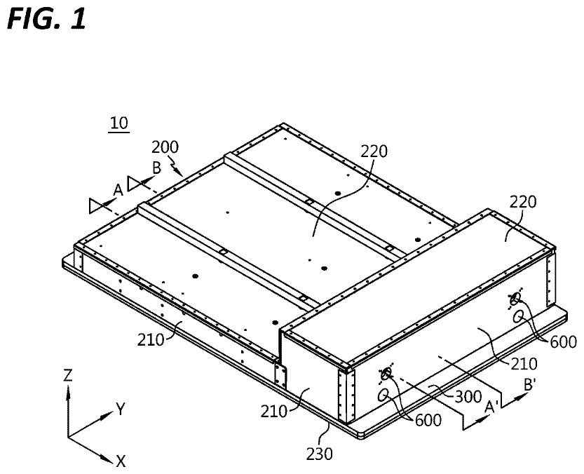

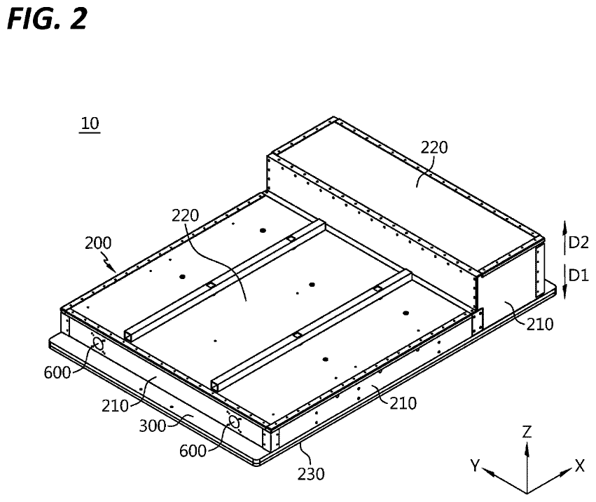

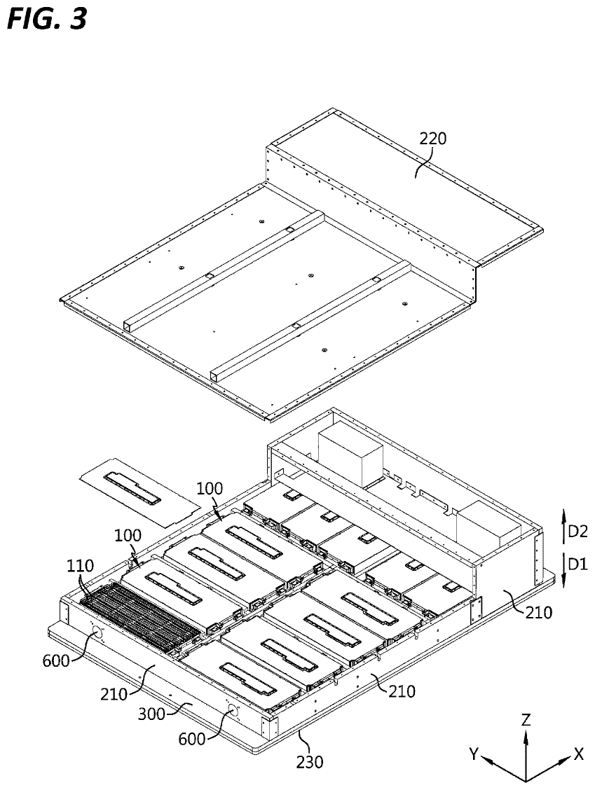

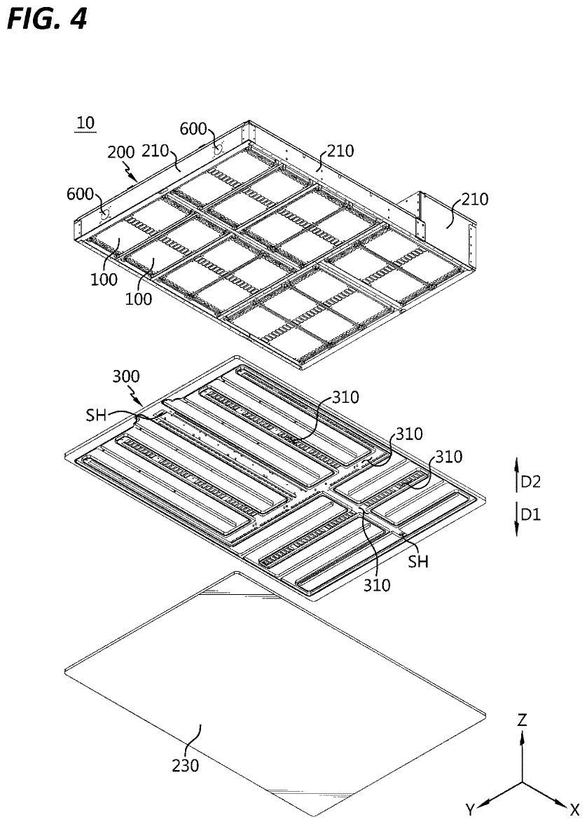

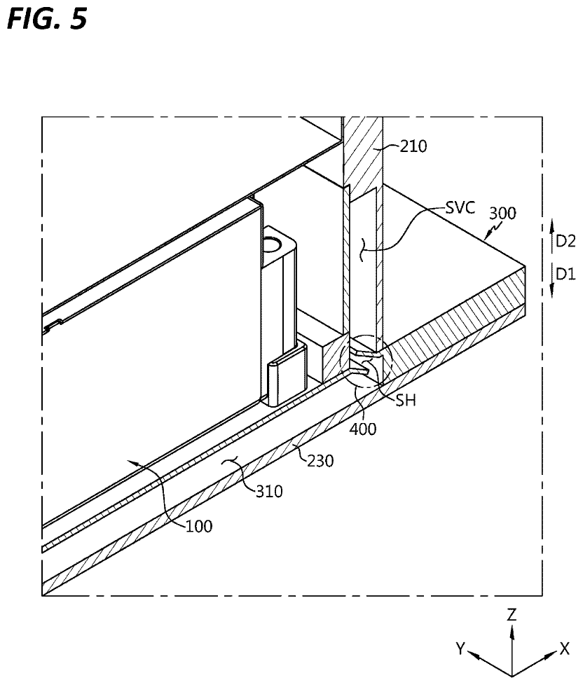

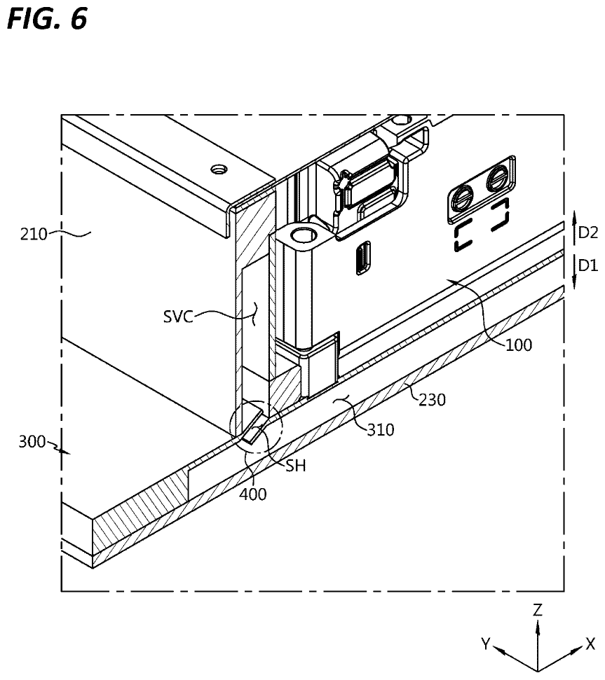

FIG. 1 is a perspective view illustrating an overall configuration of a battery pack according to an embodiment of the present disclosure, FIG. 2 is a perspective view illustrating the battery pack of FIG. 1 viewed from another direction, FIG. 3 is an exploded perspective view illustrating a pack cover separated from the battery pack according to an embodiment of the present disclosure, FIG. 4 is an exploded perspective view illustrating a bottom plate and a venting member separated from the battery pack according to an embodiment of the present disclosure, FIG. 5 is a cross-sectional perspective view illustrating a portion of a cross-section taken along line A-A′ of FIG. 1, and FIG. 6 is a cross-sectional perspective view illustrating a portion of a cross-section taken along line B-B′ of FIG. 1.

Hereinafter, a battery pack 10 according to an embodiment of the present disclosure will be described in detail with reference to FIGS. 1 to 6. The battery pack 10 according to an embodiment of the present disclosure may include a battery assembly 100, a venting member 300, side wall frames 210, and a louver member 400.

Referring to FIGS. 1 to 4, the battery assembly 100 may include a plurality of battery cells 110. The battery assembly 100 may have a predetermined width, length, and height. For example, the battery assembly 100 may have a predetermined width, length, and height in the X-axis, Y-axis, and Z-axis directions. Alternatively, the battery assembly 100 may have a predetermined width, length, and height in the Y-axis, X-axis, and Z-axis directions. In the battery assembly 100, the plurality of battery cells 110 may be stacked and arranged with respect to each other. For example, the plurality of battery cells 110 may be stacked along the X-axis or Y-axis direction in an upright state in the Z-axis direction. Arranging the plurality of battery cells in this manner may facilitate control of the discharge direction of vent gas VG, which will be described later, toward one side.

The battery pack 10 according to an embodiment of the present disclosure may include at least one battery assembly 100. The battery pack 10 according to an embodiment of the present disclosure may include a plurality of battery assemblies 100.

The battery cells 110 may be secondary batteries. The battery cells 110 may be, for example, pouch-type battery cells 110. However, the battery cells 110 are not limited thereto and may also be implemented as cylindrical or prismatic battery cells 110.

The venting member 300 may be disposed on a first direction D1 side of the battery assemblies 100. The first direction D1 may be a direction parallel to the Z-axis direction. For example, as will be described later, the first direction D1 may be the −Z direction.

When a thermal event occurs in one or more of the battery cells 110 of the battery assemblies 100, high-temperature gas, flame, and solid ejected material may be discharged from the battery cells 110, and these high-temperature gas, flame, and solid ejected materials may be collectively referred to as vent gas VG.

The venting member 300 may include a venting portion 310. The venting portions 310 may be in communication with the battery assemblies 100. The venting portions 310 may provide spaces that allow the vent gas VG discharged from the battery assemblies 100 to flow therethrough.

The side wall frames 210 may surround the battery assemblies 100 in a lateral direction. Here, the lateral direction may be understood as a direction perpendicular to the Z-axis direction. The side wall frames 210 may be disposed at the outermost sides in the lateral direction of the battery pack 10. For example, the side wall frames 210 may be respectively disposed on both sides in the X-axis direction and both sides in the Y-axis direction of the battery pack 10.

A space may be provided inside the side wall frames 210 to accommodate at least one battery assembly 100.

The side wall frames 210 may be manufactured by extrusion and may be provided in the form of an extruded frame structure.

Referring to FIGS. 5 and 6, the side venting channels SVC may be formed in the side wall frames 210. The side venting channels SVC may be in communication with the venting portions 310. The side venting channels SVC may provide spaces that allow the vent gas VG to flow therethrough. The vent gas VG flowing from the venting portions 310 may flow into the side venting channels SVC.

When the side venting channels SVC are formed in the side wall frames 210 in this manner, the flow paths of the vent gas VG may be extended, which may facilitate smooth venting of the battery pack 10. In addition, since the vent gas VG may be guided to the outside of the battery pack 10, the possibility that the vent gas VG discharged from any one of the battery cells 110 flows into, for example, other battery cells 110, may be minimized.

As illustrated in FIGS. 5 and 6, the louver member 400 may be disposed between the venting portions 310 and the side venting channels SVC. The louver member 400 may be positioned at locations where the venting portions 310 and the side venting channels SVC are connected.

The battery pack 10 may include a plurality of louver members 400. The louver member 400 may be disposed on a front side (the −X direction side) and/or a rear side (the +X direction side) of the battery pack 10.

The louver members 400 may be configured to reduce the flow energy of the vent gas VG while suppressing or preventing backflow of the vent gas VG.

The louver member 400 may be configured to change the flow direction of the vent gas VG. The vent gas VG may collide with the louver member 400 and have its flow direction changed. As the flow direction of the vent gas VG is changed by the louver member 400, the flow energy of the vent gas VG may be reduced. The louver member 400 may be configured, for example, to form a vortex in the flow of the vent gas VG. The louver member 400 may be configured, for example, in the form of a baffle structure. When the flow energy of the vent gas VG is reduced, the temperature and pressure of the vent gas VG may be lowered.

The louver member 400 may be configured to suppress or prevent backflow of the vent gas VG. For example, the louver members 400 may be configured to allow the vent gas VG to flow easily from the venting portions 310 to the side venting channels SVC, while making it difficult for the vent gas VG to flow back from the side venting channels SVC to the venting portions 310. The vent gas VG that has passed through the louver member 400 may be obstructed by the louver member 400, so that backflow may be suppressed or prevented.

When the battery pack 10 includes the louver member 400 as described above, the flow energy of the vent gas VG may be effectively reduced. As a result, the temperature and pressure of the vent gas VG discharged to the outside of the battery pack 10 may be effectively lowered, so that external ignition may be suppressed, and ejected materials such as ash or by-products and sparks in the vent gas VG may be eliminated at an early stage. In addition, since the vent gas VG may be completely discharged to the side venting channels SVC without flowing back to the venting portion 310, the backflow of the vent gas VG into the battery cells 110 or the battery assemblies 100 may be effectively suppressed or prevented, and the thermal transfer caused by the vent gas VG may also be effectively suppressed or prevented.

Accordingly, when the battery is configured as described above, effective venting may be achieved when a thermal event occurs in one or more of the battery cells 110.

As illustrated in FIGS. 5 and 6, each the louver member 400 may be provided in the form of an inclined plate. According to an embodiment, the louver member 400 may be provided in the form of an inclined plate with respect to a direction toward a venting portion 310 and a side wall frame 210. For example, as illustrated in the drawings, the louver member 400 may be provided in the form of an inclined plate with respect to the X-axis direction.

When the louver member 400 is configured as described above, it may be advantageous for guiding the flow of the vent gas VG in a specific direction or for generating a vortex in the flow of the vent gas VG, so that the flow energy of the vent gas VG may be more reliably reduced.

Referring to FIGS. 1 and 2, a battery pack 10 according to an embodiment of the present disclosure may further include venting devices 600.

The venting devices 600 may be disposed in a side wall frame 210. The venting devices 600 may be configured to allow communication between the side venting channels SVC and the outside of the battery pack 10. The venting device 600 may be in the form of a simple hole penetrating at least a portion of the side wall frame 210. Alternatively, instead of being fully open, the venting devices 600 may be configured to remain closed under normal conditions and to open when a change in pressure or temperature occurs in the side venting channels SVC.

The vent gas VG flowing from the venting portions 310 may pass through the louver member 400, flow into the side venting channels SVC, and be finally discharged to the outside of the battery pack 10 through the venting devices 600 (see FIGS. 5 and 6).

As such, when the battery pack 10 further includes the venting devices 600, the vent gas VG flowing through the side wall frame 210 may be smoothly discharged to the outside of the battery pack 10.

Referring to FIGS. 5 and 6, the venting portions 310 and the side venting channels SVC may be formed perpendicular to each other. For example, the venting portions 310 and the side venting channels SVC may be respectively formed to extend in different directions, and the extending directions of the venting portions 310 and the extending directions of the side venting channels SVC may be formed perpendicular to each other.

For instance, as illustrated in the drawings, the venting portions 310 may each extend in a direction perpendicular to the Z-axis, and the side venting channels SVC may each extend in a direction parallel to the Z-axis.

When the venting portions 310 and the side venting channels SVC are configured as described above, the vent gas VG flowing through the venting portions 310 may be appropriately guided to the side venting channels SVC while backflow to the venting portions 310 is suppressed or prevented, and at the same time, the flow direction may be changed and the flow energy may be reduced.

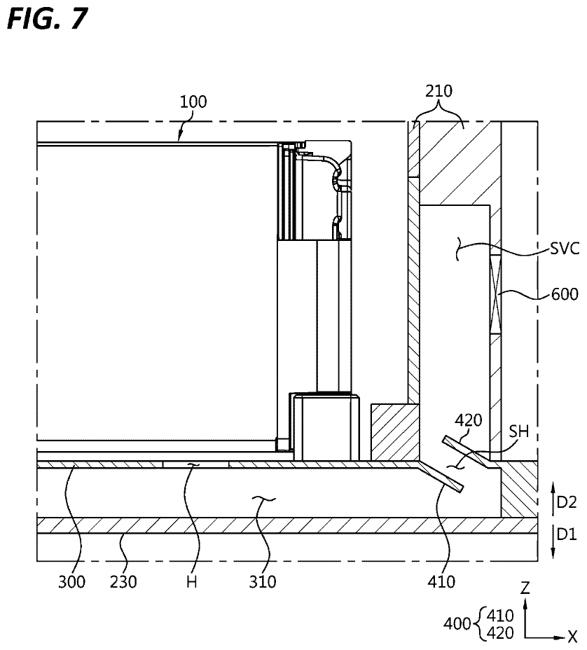

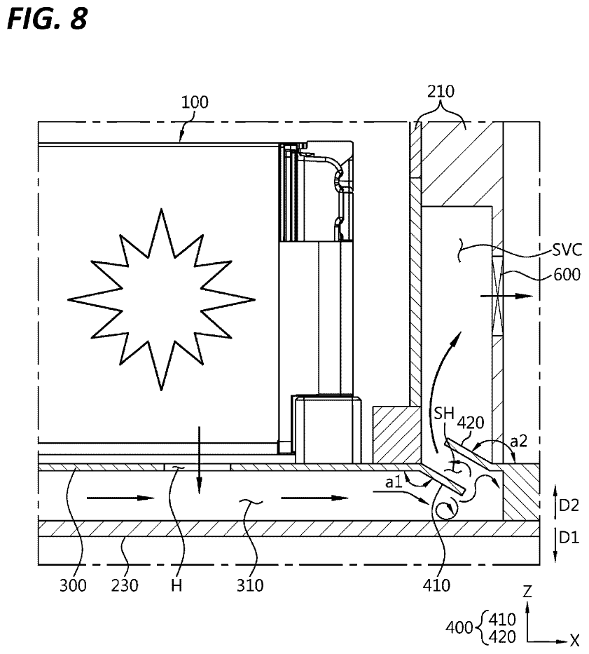

FIGS. 7 and 8 are enlarged side cross-sectional views illustrating a portion of a battery pack where a louver member is disposed, according to an embodiment of the present disclosure.

Referring to FIGS. 7 and 8, the louver member 400 may include a first louver member 410 and a second louver member 420.

The first louver member 410 may be disposed at a position relatively close to the battery assembly 100. For example, as illustrated in the drawings, in the louver member 400 disposed on the rear side (e.g., the +X direction side) of the battery pack 10, the first louver member 410 may be disposed on the −X direction side, which is relatively closer to the battery assembly 100. The first louver member 410 may extend in a direction away from the battery assembly 100. For example, the first louver member 410 may extend in the +X direction.

The second louver member 420 may be disposed at a position relatively farther from the battery assembly 100. For example, as illustrated in the drawings, in the louver member 400 disposed on the rear side of the battery pack 10, the second louver member 420 may be disposed on the +X direction side, which is relatively farther from the battery assembly 100. The second louver member 420 may extend in a direction toward the battery assembly 100. For example, the second louver member 420 may extend in the −X direction.

Meanwhile, although not illustrated in the drawings to avoid redundant description, the louver member 400 disposed on the front side (e.g., the −X direction side) of the battery pack 10 may also include the first louver member 410 and the second louver member 420. The first louver member 410 of the louver member 400 disposed on the front side of the battery pack 10 may extend from the +X direction side toward the −X direction, and the second louver member 420 may extend from the −X direction side to the +X direction.

When the vent gas VG moves from a venting portion 310 to a side venting channel SVC, the vent gas VG may sequentially pass through the first louver member 410 and the second louver member 420.

As such, when the louver member 400 is provided in a dual structure including the first louver member 410 and the second louver member 420, reduction in flow energy of the vent gas VG and suppression or prevention of backflow of the vent gas VG may be more effectively achieved.

Referring to FIGS. 7 and 8, the first louver member 410 may be formed to extend obliquely toward the first direction D1. For example, the first louver member 410 may be formed to extend obliquely toward the −Z direction.

When the first louver member 410 is configured in this way, as the vent gas VG flows from a venting portion 310 in a direction from the battery assembly 100 toward a side wall frame 210, the flow direction of the vent gas VG may be changed toward the first direction D1 when passing through the first louver member 410, thereby reducing the flow energy. After passing through the first louver member 410, the vent gas VG may be guided toward the second direction D2, thereby suppressing or preventing the backflow toward the battery assembly 100.

In addition, the second louver member 420 may be formed to extend obliquely toward the second direction D2. The second direction D2 may be understood as a direction opposite to the first direction D1. The second louver member 420 may be formed to extend obliquely, for example, toward the +Z direction.

When the second louver member 420 is configured in this way, as the vent gas VG flows in the second direction D2 from the side venting channel SVC, the flow direction of the vent gas VG may be changed toward the battery assembly 100 when passing through the second louver member 420, thereby reducing the flow energy. After passing through the second louver member 420, the vent gas VG may be guided in a direction away from the battery assembly 100, thereby suppressing or preventing backflow in the first direction D1.

Therefore, when the first louver member 410 and the second louver member 420 are configured as described above, reduction in flow energy of the vent gas VG and the suppression or prevention of backflow of the vent gas VG may be more effectively achieved.

Referring to FIGS. 7 and 8, the first louver member 410 may be formed to be inclined at an obtuse angle. For example, the first louver member 410 may be inclined at an obtuse angle toward the first direction D1 with respect to a direction from the side wall frame 210 toward the battery assembly 100. For example, as illustrated in FIG. 8, the first louver member 410 may be inclined at a first angle a1 toward the first direction D1 with respect to the −X direction, and the first angle a1 may be an obtuse angle.

When the first louver member 410 is configured as described above, the change in flow direction of the vent gas VG at the first louver member 410 may occur gradually, thereby effectively reducing the flow energy of the vent gas VG and preventing or suppressing backflow of the vent gas VG caused by a sudden pressure change.

Meanwhile, the second louver member 420 may also be inclined at an obtuse angle. For example, the second louver member 420 may be inclined at an obtuse angle toward the second direction D2 with respect to a direction from the battery assembly 100 toward the side wall frame 210. For example, as illustrated in FIG. 8, the second louver member 420 may be formed at a second angle a2 toward the second direction D2 with respect to the +X direction, and the second angle a2 may be an obtuse angle. In this case, backflow of the vent gas VG flowing from the side wall frame 210 into the venting portion 310 may be effectively suppressed or prevented.

Referring to FIGS. 7 and 8, the second louver member 420 may not overlap the venting device 600. For example, the second louver member 420 may be provided so as not to overlap the venting device 600 when viewed from the battery assembly 100 toward the side wall frame 210. For example, as illustrated in the drawings, the uppermost end of the second louver member 420 may be positioned lower than the lowermost end of the venting device 600.

When the second louver member 420 is configured in this manner, the vent gas VG that has passed through the second louver member 420 may be more smoothly introduced into the venting device 600.

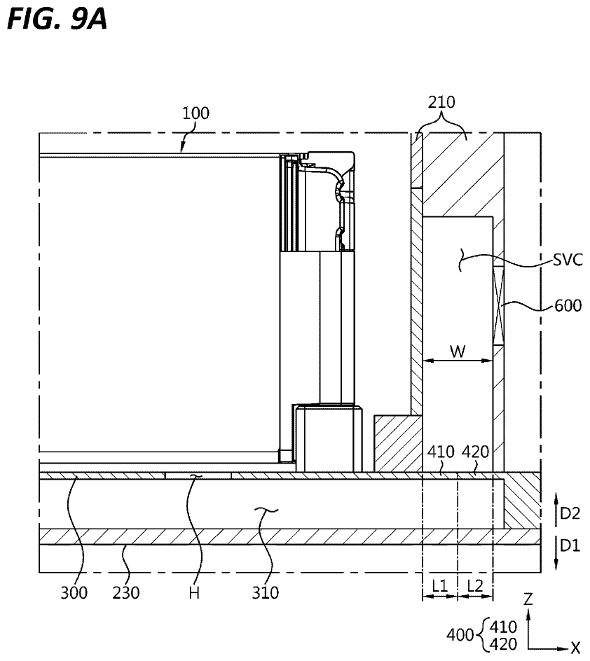

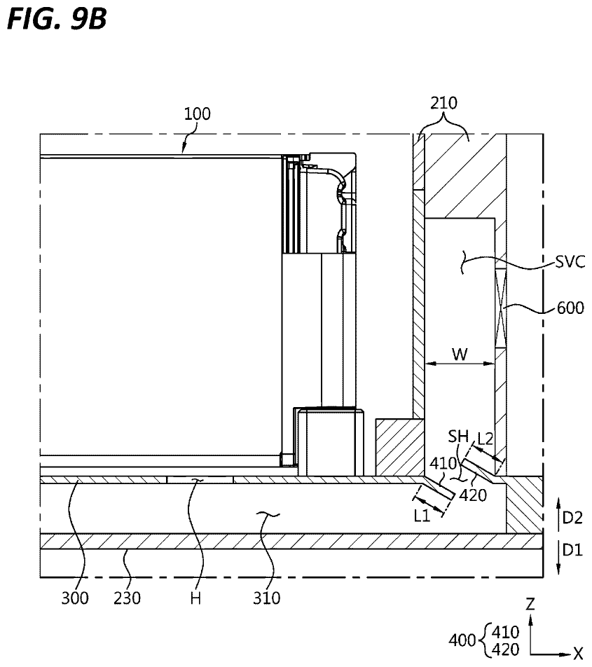

FIGS. 9A and 9B are enlarged side cross-sectional views illustrating a portion of a battery pack in which a louver member is disposed, according to a modification of an embodiment of the present disclosure.

FIG. 9A illustrates the first louver member 410 and the second louver member 420 before bending, and FIG. 9B illustrates the first louver member 410 and the second louver member 420 after bending.

Hereinafter, with reference to FIGS. 9A and 9B, a battery pack 10 according to the modification of an embodiment of the present disclosure will be described in detail. In the battery pack 10 according to the modification of an embodiment of the present disclosure, a sum of an extended length L1 of the first louver member 410 and an extended length L2 of the second louver member 420 may be equal to an internal width W of a side venting channel SVC. Here, the internal width W of the side venting channel SVC may be understood as an internal width W in a thickness direction of the side wall frame 210 (e.g., the X-axis direction).

As illustrated in FIG. 9A, the first louver member 410 and the second louver member 420 may be provided as a single-layer plate member before bending, and by undergoing a simple bending process, the first louver member 410 and the second louver member 420 may be formed as illustrated in FIG. 9B.

Therefore, when the first louver member 410 and the second louver member 420 are provided as described above, the processing of the first louver member 410 and the second louver member 420 becomes easier, so that the productivity of the battery pack 10 may be increased.

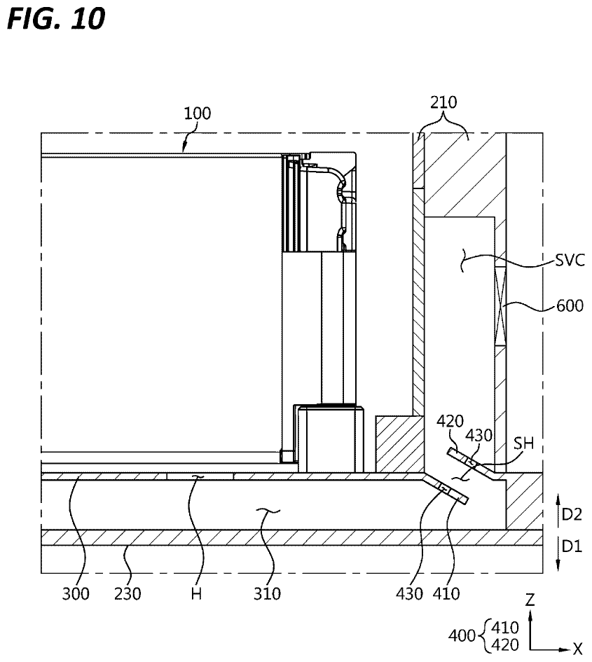

FIG. 10 is an enlarged side cross-sectional view illustrating a portion in which a louver member is disposed in a battery pack according to another embodiment of the present disclosure.

Hereinafter, with reference to FIG. 10, a battery pack 10 according to another embodiment of the present disclosure will be described in detail. In the battery pack 10 according to another embodiment of the present disclosure, the louver member 400 may include a through-hole 430. The through-hole 430 may be formed through the louver members 400 to allow vent gas VG to pass therethrough.

When the louver member 400 includes the first louver member 410 and the second louver member 420, the through-hole 430 may be provided in each of the first louver member 410 and the second louver member 420.

When the louver member 400 includes the through-hole 430 as described above, the flow of the vent gas VG may be formed more smoothly.

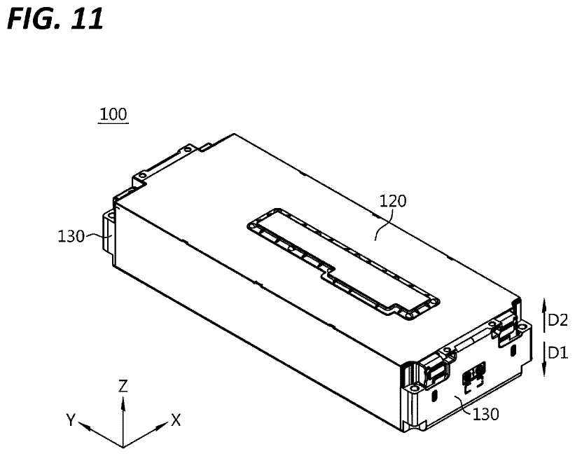

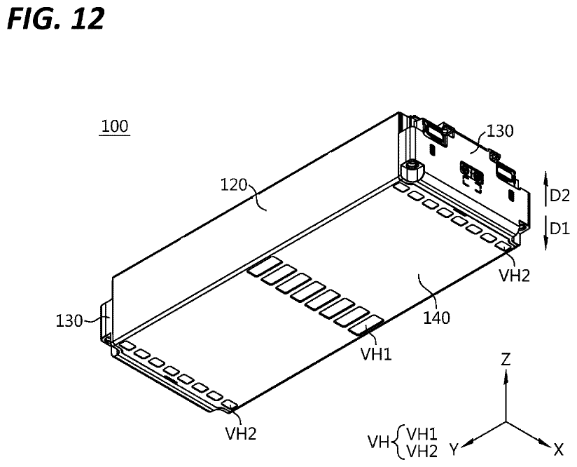

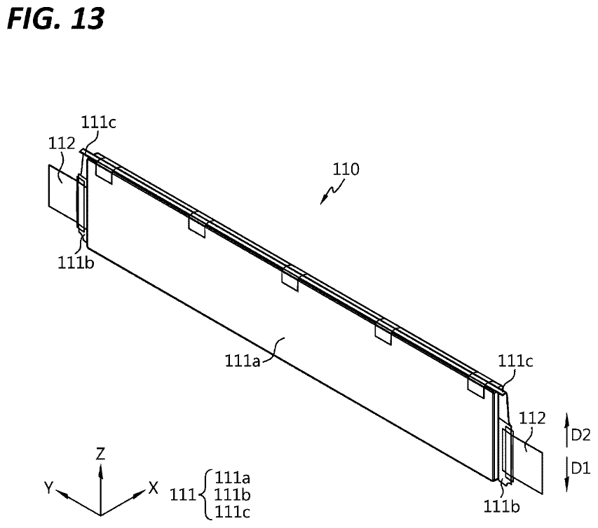

FIG. 11 is a perspective view illustrating an overall appearance of a battery assembly 100 according to an embodiment of the present disclosure, FIG. 12 is a perspective view illustrating the battery assembly 100 of FIG. 11 viewed from another direction, and FIG. 13 is a perspective view illustrating an overall appearance of a battery cell 110 according to an embodiment of the present disclosure.

Hereinafter, a battery assembly 100 according to an embodiment of the present disclosure will be described in detail with reference to FIGS. 3 and 11 to 13.

The battery assembly 100 may have a predetermined width, length, and height in the X-axis, Y-axis, and Z-axis directions, or may have a predetermined length, width, and height in the X-axis, Y-axis, and Z-axis directions. Hereinafter, only the battery assembly 100 having a predetermined width, length, and height in the X-axis, Y-axis, and Z-axis directions will be described.

The battery assembly 100 may include a battery cell 110, an assembly housing 120, end plates 130, and a bottom unit 140.

The assembly housing 120 may have one side (e.g., the first direction D1 side) open and may have a substantially U-shaped cross-section. A plurality of battery cells 110 may be accommodated inside the assembly housing 120.

The end plates 130 may cover opposite sides of the battery assembly 100. For example, the end plates 130 may cover opposite sides of the battery assembly 100 in the Y-axis direction.

The bottom unit 140 may cover the open side of the assembly housing 120. For example, the bottom unit 140 may be disposed on the first direction side D1 of the assembly housing 120. For example, the bottom unit 140 may cover the −Z-axis side of the battery assembly 100.

A vent hole VH may be formed in the bottom unit 140. The vent hole VH may be a hole that allows the vent gas VG to pass therethrough. The assembly housing 120 and the end plates 130 may have a sealed structure. Accordingly, when a thermal event occurs in the battery cell 110 and the vent gas VG is discharged, the vent gas VG may not be discharged through the assembly housing 120 in the second direction D2 or through the end plates 130. The vent gas VG may be guided to be discharged only through the vent hole VH of the bottom unit 140. Therefore, the vent gas VG in the battery assembly 100 may be guided to be discharged only in the first direction D1.

The vent hole VH may include a first vent hole VH1 and a second vent hole VH2. The first vent hole VH1 may be positioned substantially at the center of the bottom unit 140, and the second vent hole VH2 may be positioned on one side or opposite sides of the first vent hole VH1 in the length direction of the battery assembly 100. Each of the first vent hole VH1 and the second vent hole VH2 may include a plurality of holes.

A plurality of battery cells 110 may be stacked and arranged inside the battery assembly 100. The plurality of battery cells 110 may be stacked in the width direction of the battery assembly 100 in a vertically standing state.

The battery cell 110 according to an embodiment of the present disclosure may include a cell case 111. An electrode assembly in which a positive electrode, a negative electrode, and a separator are stacked may be accommodated in the cell case 111. The cell case 111 may include a housing portion 111a, sealing portions 111b, and folding portions 111c. The electrode assembly may be accommodated in the housing portion 111a. The sealing portions 111b may be at least partially sealed areas of a peripheral edge. For example, when the housing portion 111a has a substantially rectangular shape, the sealing portions 111b may be provided on three side portions among the four side portions of the peripheral edge of the housing portion 111a and may not be provided on one side portion (the −Z direction side portion). The folding portions 111c are portions where the sealing portions 111b are partially folded and may be provided, for example, on the other side portion (the +Z direction side portion) of the housing portion 111a. Electrode leads 112 are electrically connected to the electrode assembly and may be configured to protrude toward opposite sides of the battery cell 110 (e.g., opposite sides in the Y-axis direction). In addition, the electrode leads 112 may be configured to protrude in one direction rather than toward opposite sides of the battery cell 110.

On the side portions of the folding portions 111c opposite to the sealing portions 111b of the battery cell 110, so-called “bat ears” or “dog ears” that are slightly protruded outward may be formed. The second vent holes VH2 may be vent holes VH corresponding to the bat ears or dog ears.

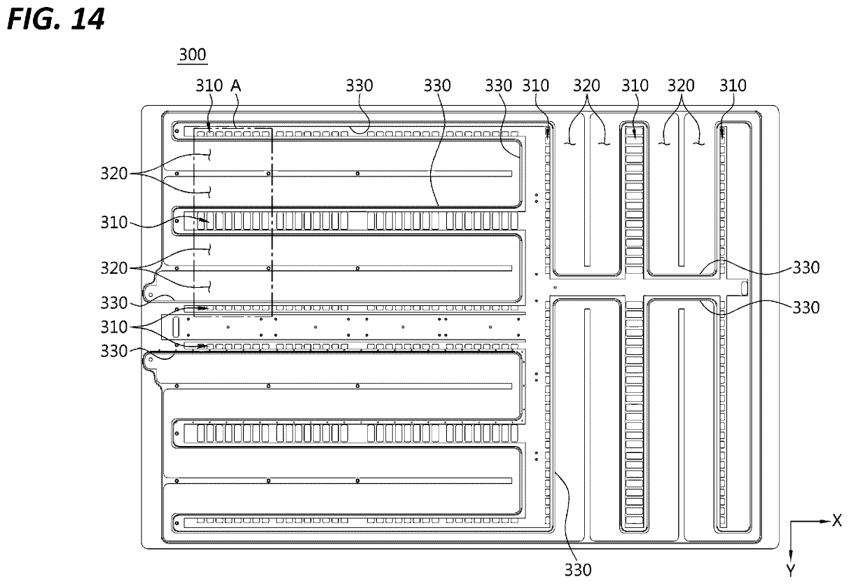

FIGS. 14 to 16 are bottom views illustrating a venting member according to an embodiment of the present disclosure.

Referring to FIGS. 5, 6, 14, and 15, in the battery pack 10 according to an embodiment of the present disclosure, the venting member 300 may further include side communication holes SH.

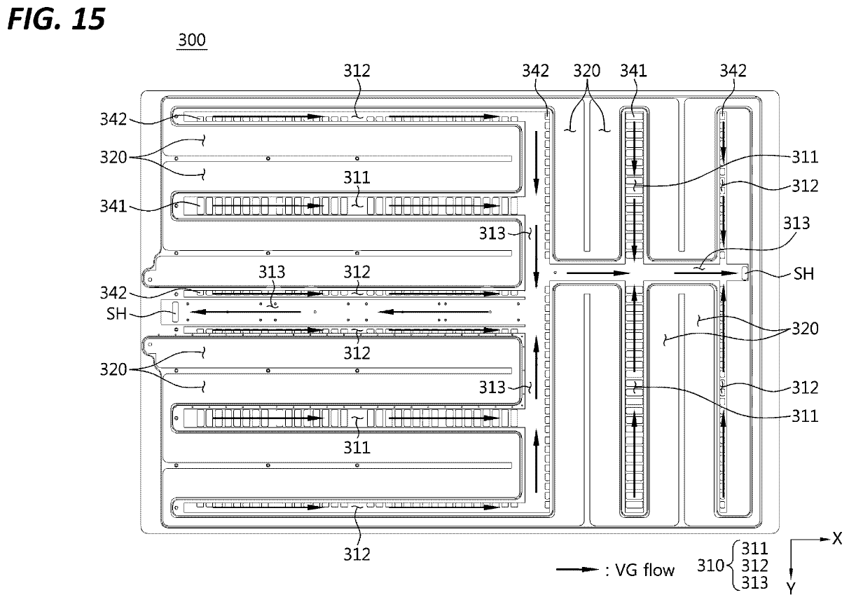

The venting member 300 may include venting portions 310 having a shape as illustrated in FIGS. 14 and 15. For example, referring to FIG. 15, the side communication holes SH may be disposed in the venting portions 310 and formed as holes that allow communication between the venting portions 310 and side venting channels SVC.

Referring again to FIGS. 5 and 6, the louver member 400 may be integrally formed with the venting member 300 at the side communication holes SH.

When the venting member 300 further includes the side communication holes SH as described above, the venting portions 310 and the side venting channels SVC may be reliably connected in communication with each other. When the louver member 400 is provided as described above, the louver member 400 may be integrally formed with the venting member 300, so that the manufacturability and rigidity of the louver member 400 may be improved. In addition, since the louver member 400 is disposed in the side communication holes SH, the louver member 400 may be precisely positioned at locations where the venting portions 310 and the side venting channels SVC are connected in communication.

Meanwhile, as illustrated in FIG. 15, the venting portions 310 may include first venting portions 311, second venting portions 312, and third venting portions 313. The first venting portions 311 may include first venting portion communication holes 341 that may be connected in communication with the first vent holes VH1. The second venting portions 312 may include second venting portion communication holes 342 that may be connected in communication with the second vent holes VH2. The third venting portions 313 may be connected in communication with the first venting portions 311 and the second venting portions 312 and may interconnect the first venting portions 311 and the second venting portions 312. The side communication holes SH may be disposed in the third venting portions 313.

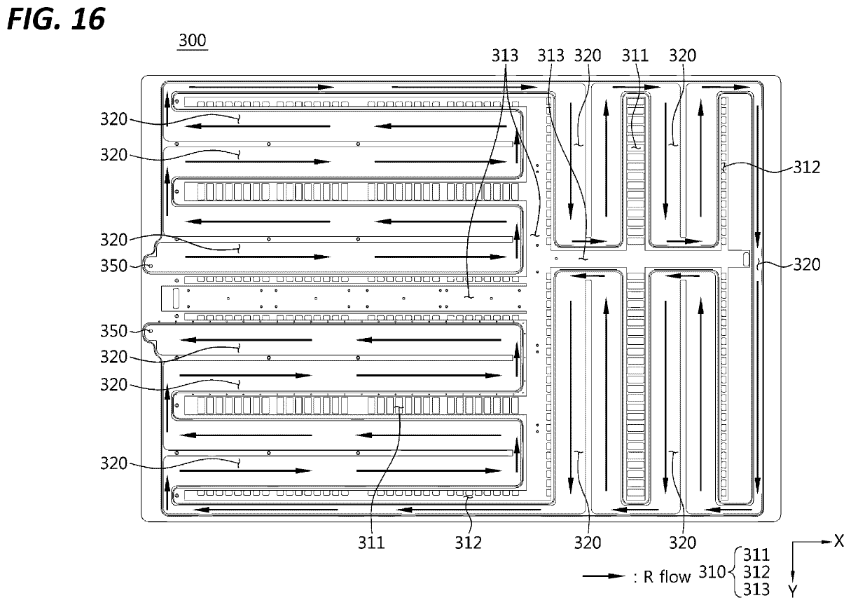

Referring to FIGS. 14 and 16, in the battery pack 10 according to an embodiment of the present disclosure, the venting member 300 may further include cooling portions 320.

The cooling portions 320 may be configured to cool the battery assemblies 100. The cooling portions 320 may also cool the vent gas VG. A flow path through which a cooling medium R may flow may be provided in the cooling portions 320. The cooling medium R may be introduced into or discharged from the cooling portions 320 through cooling medium inlets/outlets 350.

As such, when the venting member 300 further includes the cooling portions 320, the battery assemblies 100 and the venting gas VG may be effectively cooled.

Referring to FIGS. 14 and 15, the venting portions 310 and the cooling portions 320 may be alternately arranged. For example, the venting portions 310 and the cooling portions 320 may be provided in a form surrounding each other. FIG. 14 illustrates a region A corresponding to one battery assembly 100, and with reference to this region A, it may be understood that the venting portions 310 and the cooling portions 320 may be alternately arranged to correspond to the one battery assembly 100.

The venting portions 310 may include partition walls 330 protruding in a first direction D1, and the venting portions 310 and the cooling portions 320 may be partitioned from each other by the partition walls 330.

When the venting portions 310 and the cooling portions 320 are provided as described above, cooling of the vent gas VG flowing through the venting portions 310 may be more effectively performed, and the battery assemblies 100 may be more uniformly cooled.

Referring again to FIGS. 1 to 4, the first direction D1 may be a downward direction. In this case, the venting member 300 may be disposed below the battery assemblies 100. Accordingly, the discharge of the vent gas VG may be guided downward, and the battery pack 10 may be configured as a bottom venting structure.

In a vehicle in which the battery pack 10 is mounted, an occupant, such as a driver, is typically positioned above the battery cells 110. When a thermal event occurs and the vent gas VG is discharged upward from the battery cells 110, it may pose a significant risk to the occupant's safety. Therefore, when the battery pack 10 is configured as a bottom venting structure as in the present disclosure, the discharge of the vent gas VG may be guided in the downward direction opposite to the occupant, so that the occupant's safety may be ensured.

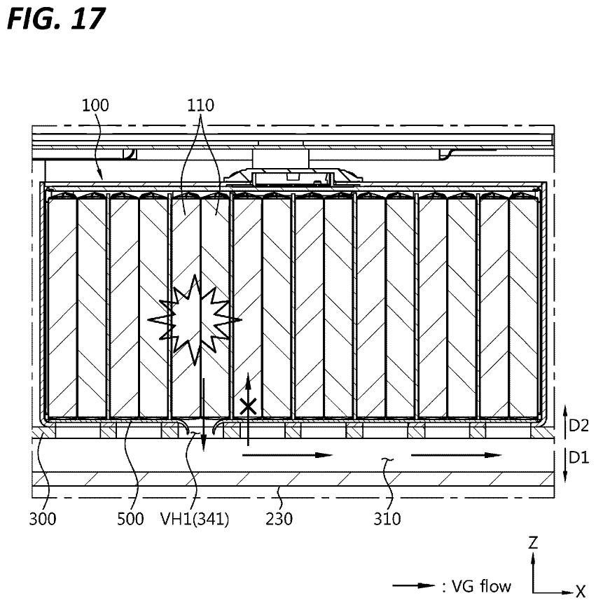

FIG. 17 is an enlarged side cross-sectional view illustrating a portion of a battery pack according to another embodiment of the present disclosure.

Hereinafter, a battery pack 10 according to another embodiment of the present disclosure will be described in detail with reference to FIG. 17. The battery pack 10 according to another embodiment of the present disclosure may further include a flame-resistant sheet 500.

The flame-retardant sheet 500 may include a heat-resistant material. Here, the heat-resistant material refers to a material having high heat resistance or flame resistance, and various materials, such as mica, may be applied. The flame-resistant sheet 500 may be disposed between the battery assemblies 100 and the venting member 300.

When the battery pack 10 further includes the flame-resistant sheet 500 as described above, backflow of the vent gas VG may be more effectively suppressed or prevented. For example, when a thermal event occurs in one of the battery cells 110 and the vent gas VG is discharged, only a portion of the flame-resistant sheet 500 corresponding to the relevant battery cell 110 may rupture, while the remaining portions may remain intact. Accordingly, backflow of the vent gas VG discharged from the corresponding battery cell 110 into other battery cells 110 may be suppressed or prevented.

Meanwhile, referring again to FIGS. 1 to 4, a battery pack 10 according to the present disclosure may further include a pack lid 220 and a bottom plate 230. The pack lid 220 may be provided to cover at least one battery assembly 100. The bottom plate 230 may be disposed on the first direction D1 side or beneath the venting member 300. The bottom plate 230 may cover the venting portions 310 and the cooling portions 320. The venting portions 310 and the cooling portions 320 of the venting member 300 may be formed in a concave shape, and the bottom plate 230 may cover the venting portions 310 and the cooling portions 320 formed in the concave shape, so that spaces for the flow of the vent gas VG and the flow of the cooling medium R may be provided. The pack case 200 may refer to an integrated structure including the side wall frames 210, the pack lid 220, and the bottom plate 230.

Meanwhile, although not illustrated, the battery pack 10 according to the present disclosure may further include various devices for controlling charging and discharging of the battery cells 100, such as a battery management system (BMS), a current sensor, and a fuse.

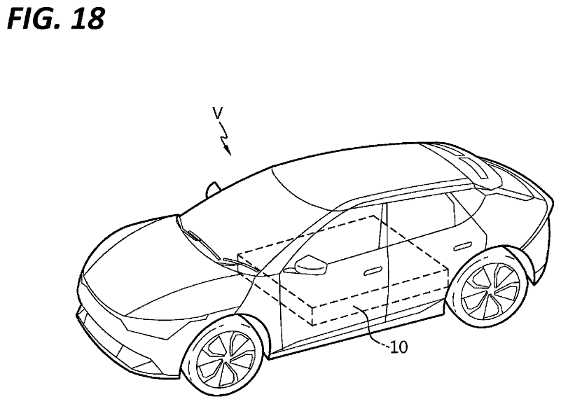

FIG. 18 is a view illustrating a vehicle according to an embodiment of the present disclosure.

Referring to FIG. 18, a battery pack 10 according to the present disclosure may be applied to a vehicle V, such as an electric vehicle or a hybrid vehicle. For example, the vehicle V according to the present disclosure may include the battery pack 10 according to the present disclosure. The battery pack 10 may be installed in a body frame below the vehicle seats or in a trunk space. In addition, the vehicle V according to an embodiment of the present disclosure may further include various other components included in a vehicle in addition to the battery pack 10. For example, the vehicle V according to an embodiment of the present disclosure may further include components such as a vehicle body, a motor, or a control unit such as an ECU (electronic control unit), in addition to the battery pack 10 according to an embodiment of the present disclosure.

In addition, it may well be possible that the battery pack 10 according to an embodiment of the present disclosure may be provided not only in a vehicle V but also in other devices, mechanisms, or facilities, such as an energy storage system (ESS) using a secondary battery.

In the present specification, terms indicating directions such as upper, lower, left, right, front, and rear are used merely for convenience of description, and it will be apparent to those ordinarily skilled in the art that such terms may vary depending on the position of the object or the position of the observer.

While the present disclosure has been described above with reference to several embodiments and drawings, the present disclosure is not limited thereto, and various changes and modifications can be made by a person ordinarily skilled in the art to which the present disclosure pertains without departing from the technical spirit of the present disclosure and the equivalent scope of the claims to be described below.

What is claimed is:

1. A battery pack comprising:
at least one battery assembly including a plurality of battery cells;
a venting member including a venting portion in communication with the battery assembly, the venting member being disposed on a first direction side of the battery assembly;
a side wall frame surrounding the battery assembly from a lateral side and having a side venting channel formed therein, the side venting channel being in communication with the venting portion; and
a louver member disposed between the venting portion and the side venting channel, the louver member being configured to reduce flow energy of vent gas while suppressing or preventing backflow of the vent gas.

2. The battery pack according to claim 1, wherein the louver member is provided in a form of an inclined plate with respect to a direction facing the venting portion and the side wall frame.

3. The battery pack according to claim 1, further comprising:
a venting device disposed on the side wall frame and configured to allow communication between the side venting channel and the outside of the battery pack.

4. The battery pack according to claim 1, wherein the venting portion and the side venting channel are formed perpendicular to each other.

5. The battery pack according to claim 1, wherein the louver member includes:
a first louver member extending in a direction away from the battery assembly from a position relatively closer to the battery assembly; and
a second louver member extending in a direction toward the battery assembly from a position relatively farther from the battery assembly.

6. The battery pack according to claim 5, wherein
the first louver member is formed to extend obliquely in a first direction, and
the second louver member is formed to extend obliquely in a second direction opposite to the first direction.

7. The battery pack according to claim 5, wherein the first louver member is obliquely formed at an obtuse angle in the first direction with respect to a direction from the side wall frame toward the battery assembly.

8. The battery pack according to claim 5, further comprising:
a venting device disposed on the side wall frame and configured to allow communication between the side venting channel and the outside of the battery pack,
wherein the second louver member does not overlap the venting device when viewed from the battery assembly toward the side wall frame.

9. The battery pack according to claim 5, wherein
the sum of the extended length of the first louver member and the extended length of the second louver member is equal to the internal width of the side venting channel.

10. The battery pack according to claim 1, wherein the louver member includes a through-hole formed therethrough to allow the vent gas to pass.

11. The battery pack according to claim 1, wherein
the venting member further includes a side communication hole that allows communication between the venting portion and the side venting channel, and
the louver member is integrally formed with the venting member at the side communication hole.

12. The battery pack according to claim 1, wherein the venting member further includes a cooling portion configured to cool the battery assembly.

13. The battery pack according to claim 12, wherein the venting portion and the cooling portion are alternately arranged.

14. The battery pack according to claim 1, wherein the first direction is a downward direction.

15. The battery pack according to claim 1, further comprising:
a fire-resistant sheet disposed between the battery assembly and the venting member.

16. A vehicle comprising at least one battery pack according to claim 1.

17. A battery pack case comprising:
an accommodation space configured to accommodate at least one battery assembly including a plurality of battery cells;
a venting member including a venting portion in communication with the battery assembly and disposed on a first direction side of the battery assembly;
a side wall frame surrounding the battery assembly from a lateral side and having a side venting channel formed therein, the side venting channel being in communication with the venting portion; and
a louver member disposed between the venting portion and the side venting channel, the louver member being configured to reduce flow energy of vent gas while suppressing or preventing backflow of the vent gas.

18. The battery pack case according to claim 17, wherein the louver member is provided in a form of an inclined plate with respect to a direction facing the venting portion and the side wall frame.

19. The battery pack case according to claim 17, further comprising:
a venting device disposed on the side wall frame and configured to allow communication between the side venting channel and the outside of the battery pack.

20. The battery pack case according to claim 17, wherein the venting portion and the side venting channel are formed perpendicular to each other.
